(19) United States
(12) Patent Application Publication
(10) Pub. No.: US 2016/0185925 A1
(43) Pub. Date: Jun. 30, 2016

(54) LAMINATING FILM FOR USE IN ORGANIC GLASS

(71) Applicant: DAI NIPPON PRINTING CO., LTD., Tokyo (JP)

(72) Inventors: Akihisa Noda, Tokyo (JP); Haruka Mishiba, Tokyo (JP); Hiroyuki Atake, Tokyo (JP)

(21) Appl. No.: 14/908,827

(22) PCT Filed: Jul. 29, 2013
(86) PCT No.: PCT/JP2013/070480

§ 371 Date: Jan. 29, 2016

(51) Int. Cl. C08J 7/04; B32B 27/36; B29C 45/14; C09D 169/00; B29B 11/14; B32B 27/08; B32B 27/30

(52) U.S. Cl. CPC C08J 7/042; B32B 27/08; B32B 27/365; B32B 27/308; C09D 169/00; B29B 11/14; B29C 45/14; C08J 2369/00; B32B 2250/24; B32B 2255/26; B32B 2255/10; B32B 2307/71; B29K 2069/00

(57) ABSTRACT

The purpose of the present invention is to provide: a laminating film which is to be used in an organic glass, which suffers from little discoloration of a resin film even after electron beam irradiation and thus exhibits excellent transparency, and which exhibits excellent weather resistance and scratch resistance and excellent three-dimensional molding properties; and an organic glass using the same. In a laminating film which is to be used in an organic glass and which comprises both a resin film that contains a triazine ultraviolet absorber and a surface protection layer, the surface protection layer is formed of a cured product of an electron-beam-curable resin composition that comprises a polycarbonate (meth)acrylate and a polyfunctional (meth)acrylate at a mass ratio of 98:2 to 50:50. An organic glass is manufactured using the laminating film.

### TECHNICAL FIELD

The present invention relates to a laminating film for use in organic glass, and an organic glass produced using the laminating film for use in organic glass.

### BACKGROUND ART

In recent years, resin molded articles and resin plates formed of acrylic resin and polycarbonate resin have been increasingly used in front doors and exterior materials for general dwelling houses, floor materials and structure exteriors such as external walls and roofs for public facilities, or structure exteriors for automobiles, trains, vessels, aircrafts, industrial machineries and heavy machineries. These resin articles are light and have no risk of being damaged and scattered under impact, and therefore, among them, those having transparency have come into use as alternative members for inorganic glasses (i.e. organic glasses) particularly in applications in which inorganic glasses were used in the past, such as window glass for buildings, or windows, sunroof materials, head lamps and head lamp covers for automobiles, among the above-described applications.

When these articles are used in the above-mentioned applications, they are exposed to direct sunlight and wind and rain everyday, and therefore required to have extremely strict weather resistance. In the above-described applications, properties such as scratch resistance and chemical resistance is also required in view of natural scratching caused by wind and rain, dust or the like, scratching in cleaning and washing operations, attacked by organic solvent due to the use of an organic solvent etc. for washing out graffiti or excessive stains, and so on. For satisfying the above-mentioned properties, a high-weather-resistance surface protective layer formed using a curable resin such as a heat-curable resin, an ultraviolet-curable resin or an electron beam-curable resin is provided on a resin plate such as that of acrylic resin or polycarbonate resin with a resin film etc. interposed therebetween.

For example, Patent Document 1 proposes a resin molded article excellent in scratch resistance, wherein an acrylic resin film or sheet containing 0.1 to 10% by weight of an ultraviolet absorber is laminated to at least one surface of a polycarbonate resin film or sheet, one surface of the laminate on the acrylic resin layer side is subjected to a hard coat treatment, and the laminate is laminated to and integrated with a thermoplastic resin molded article with the hard coat-treated layer as an outer layer. Patent Document 2 discloses a polycarbonate resin laminate for a liquid crystal display cover, the laminate having a total thickness of 0.4 to 1.5 mm with a 50 to 120 μm-thick acrylic resin layer laminated to one surface of a polycarbonate resin layer by co-extrusion, wherein the acrylic resin layer is subjected to a hard coat treatment, and the laminate is used in such a manner that a surface, to which acrylic resin is not co-extruded, is situated on the liquid crystal side. Patent Document 2 also describes that this acrylic resin contains 0.01 to 3% by weight of a benzotriazole-based, benzophenone-based, salicylic acid phenyl ester-based or triazine-based ultraviolet absorber. The hard coat treatment is performed by ultraviolet-curing or heat-curing using a commercial available hard coat agent etc.

Patent Document 3 proposes a scratch-resistance resin plate including a resin substrate, and a cured film formed on a surface of the resin substrate, wherein the resin substrate is formed by laminating an acrylic resin layer to at least one surface of a polycarbonate resin layer, the polycarbonate resin layer and the acrylic resin layer each contain an ultraviolet absorber, the amount of the ultraviolet absorber per 1 m² of the acrylic resin layer is 0.005 to 1 g/m², the amount of the ultraviolet absorber per 1 m² of the resin substrate is 0.5 to 2 g/m², and the cured film is formed on at least the surface of the acrylic resin layer.

For obtaining more excellent three-dimensional moldability and scratch resistance, an attempt has been made to employ an electron beam-curable resin as a resin for forming a surface protective layer. However, there has been the problem that the surface protective layer in each of the above-described inventions is formed by ultraviolet-curing or heat-curing, and is not intended for the use of an electron beam-curable resin, and therefore when a surface protective layer is to be formed by curing the electron beam-curable resin by application of an electron beam, a resin sheet or resin layer serving as a support base on which the surface protective layer is provided is discolored. The discoloration problem is prominent particularly in materials having high transparency comparable to that of inorganic glass, such as acrylic resin and polycarbonate resin, and resultantly high transparency is compromised.

### PRIOR ART DOCUMENTS

### Patent Documents

Patent Document 1: Japanese Patent Laid-open Publication No. 7-137210

Patent Document 2: Japanese Patent Laid-open Publication No. 2007-237700

Patent Document 3: Japanese Patent Laid-open Publication No. 2010-221648

### SUMMARY OF THE INVENTION

### Problems to be Solved by the Invention

In view of the problems described above, an object of the present invention is to provide a laminating film for use in organic glass which exhibits excellent transparency with little discoloration of a resin film after application of an electron beam and which exhibits excellent weather resistance and scratch resistance, and excellent three-dimensional moldability; and an organic glass produced using the laminating film for use in organic glass.

### Means for Solving the Problem

The present inventors have extensively conducted studies for achieving the above-mentioned object, and resultantly found that when a laminate including a resin film containing a triazine-based ultraviolet absorber, and a surface protective layer is used as a laminating film for use in organic glass, and the surface protective layer is formed from a cured product of an electron beam-curable resin composition containing a polycarbonate (meth)acrylate and a polyfunctional (meth)acrylate at a mass ratio of 98:2 to 50:50, the laminating film for use in organic glass can exhibit excellent transparency with little discoloration after application of an electron beam as well as excellent weather resistance, scratch resistance and three-dimensional moldability. The present invention has been completed by further conducting studies based on the above-mentioned findings. That is, the present invention provides inventions of aspects as listed below.

Item 1. A laminating film for use in organic glass including a resin film containing a triazine-based ultraviolet absorber, and a surface protective layer, the surface protective layer including a cured product of an electron beam-curable resin composition containing a polycarbonate (meth)acrylate and a polyfunctional (meth)acrylate at a mass ratio of 98:2 to 50:50.
Item 2. The laminating film for use in organic glass according to item 1, including a primer layer between the resin film and the surface protective layer.
Item 3. The laminating film for use in organic glass according to item 1 or 2, wherein the polyfunctional (meth)acrylate is tri- or more functional.
Item 4. The laminating film for use in organic glass according to any one of items 1 to 3, wherein the polycarbonate (meth)acrylate has a weight average molecular weight of more than 2000 and 50000 or less.
Item 5. The laminating film for use in organic glass according to any one of items 1 to 4, wherein the electron beam-curable resin composition contains a triazine-based ultraviolet absorber and/or a hindered amine-based light stabilizer.
Item 6. The laminating film for use in organic glass according to any one of items 2 to 5, wherein a primer layer forming resin composition for forming a primer layer is a composition containing a polymer polyol and a curing agent.
Item 7. The laminating film for use in organic glass according to any one of items 2 to 6, wherein the primer layer forming resin composition for forming a primer layer contains a triazine-based ultraviolet absorber and/or a hindered amine-based light stabilizer.
Item 8. The laminating film for use in organic glass according to any one of items 1 to 7, wherein the resin that forms the resin film is at least one selected from polycarbonate resin, acrylic resin and polyester resin.
Item 9. The laminating film for use in organic glass according to any one of items 1 to 8, which is integrated with a resin for a base substrate by an injection molding method.
Item 10. An organic glass including a resin base on the resin film side of a laminating film for use in organic glass including a resin film containing a triazine-based ultraviolet absorber, and a surface protective layer, the surface protective layer including a cured product of an electron beam-curable resin composition containing a polycarbonate (meth)acrylate and a polyfunctional (meth)acrylate at a mass ratio of 98:2 to 50:50.
Item 11. A method for producing a laminating film for use in organic glass, the method including, sequentially, the steps of:
(I) forming an uncured resin layer on a resin film containing a triazine-based ultraviolet absorber by applying an electron beam-curable resin composition containing a polycarbonate (meth)acrylate and a polyfunctional (meth)acrylate at a mass ratio of 98:2 to 50:50; and
(II) forming a surface protective layer by irradiating the uncured resin layer with an electron beam to cure the uncured resin layer.
Item 12. The method for producing a laminating film for use in organic glass according to item 11, wherein in the step (1), an uncured resin layer is formed on a resin film by applying a primer layer forming resin composition, and then applying an electron beam-curable resin composition.
Item 13. A method for producing an organic glass, the method including, sequentially, the steps of:
(α) disposing the laminating film for use in organic glass according to any one of items 1 to 9 in a mold:
(β) injecting a resin for a base substrate into the mold; and
(γ) taking an organic glass from the mold after the resin for a base substrate is cooled.

### Advantages of the Invention

According to the present invention, there can be provided a laminating film for use in organic glass which exhibits excellent transparency with little discoloration of a resin film after application of an electron beam and which exhibits excellent weather resistance and scratch resistance, and excellent three-dimensional moldability; and an organic glass produced using the laminating film for use in organic glass.

### BRIEF DESCRIPTION OF THE DRAWINGS

FIG. 1 is a schematic view showing a cross section of a laminating film for use in organic glass of the present invention.

FIG. 2 is a schematic view showing a cross section of one example of a preferred aspect of the laminating film for use in organic glass of the present invention.

FIG. 3 is a schematic view showing a cross section of one example of a preferred aspect of an organic glass of the present invention.

### EMBODIMENTS OF THE INVENTION

### [Laminating Film for Use in Organic Glass]

The laminating film for use in organic glass of the present invention includes a resin film containing a triazine-based ultraviolet absorber, and a surface protective layer, the surface protective layer including a cured product of an electron beam-curable resin composition containing a polycarbonate (meth)acrylate and a polyfunctional (meth)acrylate at a mass ratio of 98:2 to 50:50.

In the present invention, the organic glass is a member formed of an organic material, and means a member that is used as an alternative member for an inorganic glass generally containing silicon dioxide as a main component, such as silicate glass or quartz.

In the present invention, the (meth)acrylate means an acrylate or a methacrylate, and other similar expressions have the same meaning.

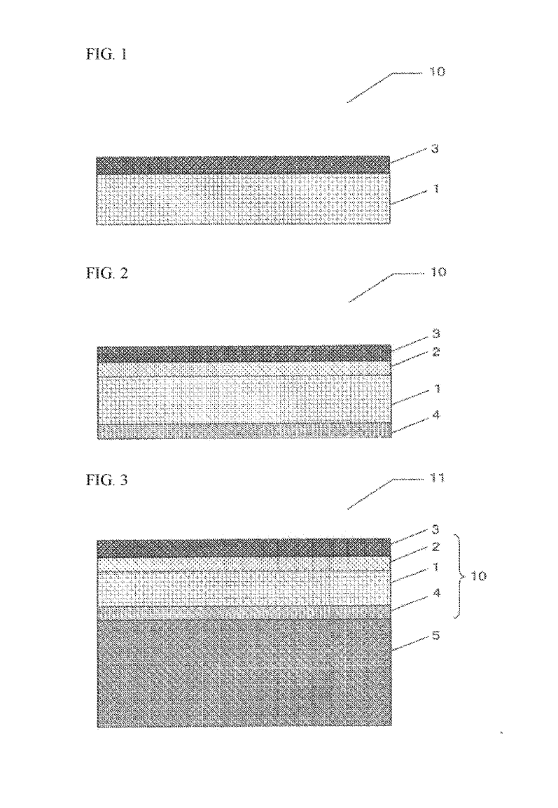

The laminating film for use in organic glass of the present invention will be described with reference to the drawings. FIG. 1 is a schematic view showing a cross section of a laminating film for use in organic glass of the present invention. In FIG. 1, a laminating film 10 having a layer structure in which a surface protective layer 3 is provided on a resin film 1 is shown. FIG. 2 is a schematic view showing a cross section of one preferred aspect of the laminating film for use in organic glass of the present invention. In FIG. 2 is shown the laminating film 10 including a primer layer 2 between the resin film 1 and the surface protective layer 3, and including an adhesive layer 4 on a surface of the resin film 1 on a side opposite to a surface provided with the surface protective layer 3. Hereinafter, the layers of the laminating film for use in organic glass of the present invention will be described.

### <<Resin Film>>

The resin film can be used without particular limitation as long as it is a resin film that is normally used as a base material, but the resin film preferably has transparency. For transparency, the resin film may be colorless and transparent, colored and transparent or translucent, and may be provided with, for example, a pattern as long as at least a part thereof has transparency. Here, the transparency means that the light transmittance in the visible light range of 380 to 780 nm is 60% or more, preferably 70% or more, more preferably 80% or more.

In the case where the laminating film of the present invention is used as an alternative product for a ground glass, the resin film may have no transparency as a matter of course.

The resin that forms the resin film is preferably one having high transparency, and preferred examples thereof include cycloolefin resins obtained from a cycloolefin such as norbomene, dicyclopentadiene or tetracyclododecene, silicone resin, polycarbonate resin, epoxy resin, acrylic resin such as polymethyl methacrylate or polybutyl methacrylate, phenol resin, polyimide resin, benzoxazine resin, oxetane resin, polyester resin such as polyethylene terephthalate resin or polybutylene terephthalate resin. Among them, polycarbonate resin, acrylic resin and polyester resin are preferable from the viewpoint of transparency.

The thickness of the resin film is normally about 25 to 200 μm, preferably 40 to 125 μm, more preferably 50 to 100 μm. A thickness of about 25 m or more is preferable because defects such as creases and curls are hard to occur in the resin film, so that handling is facilitated. On the other hand, a thickness of about 200 μm or less is preferable because lamination is facilitated.

### (Triazine-Based Ultraviolet Absorber)

The resin film contains a triazine-based ultraviolet absorber. The triazine-based ultraviolet absorber has a high ultraviolet light absorbing ability that is essential in exhibition of weather resistance, and the triazine-based ultraviolet absorber is hardly degraded even by high energy from ultraviolet rays etc., and also has a much higher effect of suppressing discoloration of the resin film after application of an electron beam as compared to other ultraviolet absorbers.

Preferred examples of the triazine-based ultraviolet absorber include hydroxyphenyl triazine-based ultraviolet absorbers such as 2-(2-hydroxy-4-[1-octyloxycarbonylethoxy]phenyl-4,6-bis(4-phenylphenyl)-1,3,5-triazine (manufactured by BASF SE, trade name “TINUVIN 479”); a reaction product of 2-(4,6-bis(2,4-dimethylphenyl)-1,3,5-triazine-2-yl)-5-hydroxyphenyl and oxirane {particularly, [C10-C16, mainly C12-C13 alkyloxy)methyl]oxirane} (manufactured by BASF SE, trade name “TINUVIN 400”); a reaction product of 2-(2,4-dihydroxyphenyl)-4,6-bis-(2,4-dimethylphenyl)-1,3,5-triazine and (2-ethylhexyl)-glycidic acid ester (manufactured by BASF SE, trade name “TINUVIN 405”); and 2,4-bis[2-hydroxy-4-butoxyphenyl]-6-(2,4-dibutoxyphenyl)-1,3,5-triazine (manufactured by BASF SE, trade name “TINUVIN 460”). These triazine-based ultraviolet absorbers may be used alone, or may be used in combination of two or more thereof.

The content of the triazine-based ultraviolet absorber in the resin film is 0.1 to 15 parts by mass, more preferably 0.5 to 10 parts by mass, further preferably 1 to 7 parts by mass based on 100 parts by mass of the resin that forms the resin film. When the content of the triazine-based ultraviolet absorber is in the above-mentioned range, an excellent effect of suppressing discoloration of the resin film and an excellent ultraviolet light absorbing ability are obtained while transparency is not reduced, and occurrence of so called breed-out can also be suppressed in which the ultraviolet absorber seeps out of the resin film to reduce the ultraviolet light absorbing ability, or stickiness or a reduction in transparency occurs.

### (Light Stabilizer)

The resin film may contain a weather resistance improver such as a light stabilizer as desired for further improving weather resistance.

The light stabilizer is preferably a hindered amine-based light stabilizer (HALS). Preferred examples of the hindered amine-based light stabilizer include bis(1,2,2,6,6-pentamethyl-4-piperidyl) sebacate (manufactured by BASF SE, trade name “TINUVIN 292”): decanedioic acid-bis(2,2,6,6-tetramethyl-1-(octyloxy)-4-piperidinyl) ester (manufactured by BASF SE, trade name “TINUVIN 123”), bis(1,2,2,6,6-pentamethyl-4-piperidinyl) sebacate, methyl(1,2,2,6,6-pentamethyl-4-piperidinyl) sebacate, 2,4-bis[N-butyl-N-(1-cyclohexyloxy-2,2,6,6-tetramethylpiperidine-4-yl)amino]-6-(2-hydroxyethylamine)-1,3,5-triazine.

The content of the light stabilizer in the resin film is normally 0.05 to 10 parts by mass, preferably 0.5 to 7 parts by mass, more preferably 1 to 5 parts by mass, further preferably 2 to 5 parts by mass based on 100 parts by mass of the resin that forms the resin film. When the content of the light stabilizer is in the above-mentioned range, excellent weather resistance is obtained while transparency is not reduced, and bleed-out can also be suppressed.

One or both of the surfaces of the resin film can be subjected to a physical or chemical surface treatment by an oxidation method or a surface roughening method as desired for the purpose of improving adhesion with a surface protective layer as described above or a primer layer that is preferably provided.

Examples of the oxidation method include a corona discharge treatment method, a chromium oxidation treatment method, a flame treatment method, a hot air treatment method and an ozone/ultraviolet treatment method, and examples of the surface roughening method include a sand blasting method and a solvent treatment method. Such a surface treatment is appropriately selected according to the type of the resin film, but generally a corona discharge treatment method is preferably used from the viewpoint of an effect and operability.

### <<Surface Protective Layer>>

The surface protective layer is a layer for imparting hard coat characteristics such as weather resistance and scratch resistance and excellent three-dimensional moldability to the laminating film of the present invention. The surface protective layer is provided on one surface of the resin film as shown in FIG. 1 and FIG. 2. The surface protective layer is a layer including a cured product of an electron beam-curable resin composition containing a polycarbonate (meth)acrylate and a polyfunctional (meth)acrylate at a mass ratio of 98:2 to 50:50. The electron beam-curable resin composition here refers to a resin composition having electron beam curability, i.e. a resin composition which is crosslinked and cured when irradiated with an electron beam.

The electron beam-curable resin composition is a resin composition containing an electron beam-curable resin, and other additives that are added as necessary. In the present invention, the electron beam-curable resin in the electron beam-curable resin composition contains at least a polycarbonate (meth)acrylate and a polyfunctional (meth)acrylate at a mass ratio of 98:2 to 50:50.

If the ratio of the polycarbonate (meth)acrylate is above the above-mentioned range (i.e. the amount of the polycarbonate (meth)acrylate is more than 98 parts by mass based on 100 parts by mass of the total of the polycarbonate (meth)acrylate and the polyfunctional (meth)acrylate), scratch resistance is deteriorated. On the other hand, if the ratio of the polycarbonate (meth)acrylate is below the above-mentioned range (i.e. the amount of the polycarbonate (meth)acrylate is less than 50 parts by mass based on 100 parts by mass of the total of the polycarbonate (meth)acrylate and the polyfunctional (meth)acrylate), three-dimensional moldability is deteriorated.

For obtaining excellent scratch resistance and three-dimensional moldability, the mass ratio of the polycarbonate (meth)acrylate and the polyfunctional (meth)acrylate is preferably 98:2 to 60:40, more preferably 98:2 to 70:30, further preferably 95:5 to 80:20, especially preferably 94:6 to 80:20. In the present invention, an electron beam-curable resin composition having a specific composition as described above is used for formation of the surface protective layer, and thus mutually contrary properties: scratch resistance and three-dimensional moldability can be improved.

### (Polycarbonate (Meth)Acrylate)

The polycarbonate (meth)acrylate for use in the present invention is not particularly limited as long as it has a carbonate bond on the polymer main chain, and has a (meth)acrylate at the end or on the side chain. The polycarbonate (meth)acrylate is preferably bi- or more functional, more preferably bi- to icosa-functional, further preferably bi- to octa-functional from the viewpoint of crosslinking and curing. The unsaturated bond equivalent of the polycarbonate (meth)acrylate is 400 or more from the viewpoint of three-dimensional moldability, and preferably 15000 or less from the viewpoint of curing, and more preferably 600 or more and 10000 or less, further preferably 800 or more and 8000 or less. Here, the number of functions in the polycarbonate (meth)acrylate refers to the number of ethylenically unsaturated bonds ((meth)acryloyl groups) existing in one molecule, and the unsaturated bond equivalent of the polycarbonate (meth)acrylate refers to a value obtained by dividing the molecular weight by the number of ethylenically unsaturated bonds ((meth)acryloyl groups) of the polycarbonate (meth)acrylate.

The polycarbonate (meth)acrylate is obtained by, for example, converting some or all of hydroxyl groups of a polycarbonate polyol into a (meth)acrylate ((meth)acrylic acid ester). This esterification reaction can be carried out in accordance with a usual esterification reaction. Examples thereof include 1) a method in which a polycarbonate polyol and a (math)acrylic acid halide are condensed in the presence of a base; 2) a method in which a polycarbonate polyol and a (meth)acrylic anhydride are condensed in the presence of a catalyst; and 3) a method in which a polycarbonate polyol and a (meth)acrylic acid are condensed in the presence of an acid catalyst.

The polycarbonate polyol is a polymer having a carbonate bond in the polymer main chain, and having 2 or more, preferably 2 to 50, further preferably 3 to 50 hydroxyl groups at the end or side chain. A typical method for producing the polycarbonate polyol is a method using a polycondensation reaction of a diol compound (I), a polyhydric alcohol (11) of tri- or more valence, and a compound (III) as a carbonyl component.

The diol compound (I) which is used as a raw material is represented by the general formula HO—R¹—OH. Here, R¹ is a divalent hydrocarbon with a carbon number of 2 to 20, and may include an ether bond in the group. R¹ is, for example, a linear or branched alkylene group, a cyclohexylene group or a phenylene group.

Preferred specific examples of the diol compound include ethylene glycol, 1,2-propylene glycol, diethylene glycol, dipropylene glycol, triethylene glycol, polyethylene glycol, neopentyl glycol, 1,3-propanediol, 1,4-butanediol, 1,5-pentanediol, 3-methyl-1,5-pentanediol, 1,6-hexanediol, 1,8-octanediol, 1,3-bis(2-hydroxyethoxy)benzene, 1,4-bis(2-hydroxyethoxy)benzene, neopentyl glycol, 1,4-cyclohexanediol and 1,4-cyclohexanedimethanol. These diols may be used alone, or may be used in combination of two or more thereof.

Preferred examples of the polyhydric alcohol (II) of tri- or more valence include alcohols such as trimethylolpropane, trimethylolethane, pentaerythritol, ditrimethylolpropane, dipentaerythritol, glycerin and sorbitol. Further, the polyhydric alcohol may be an alcohol having a hydroxyl group with 1 to 5 equivalents of ethylene oxide, propylene oxide or other alkylene oxide added to the hydroxyl group of the polyhydric alcohol. These polyhydric alcohols may be used alone, or may be used in combination of two or more thereof.

The compound (III) as a carbonyl component is preferably a compound selected from a carbonic acid diester, phosgene and an equivalent thereof. Preferred specific examples thereof include carbonic acid diesters such as dimethyl carbonate, diethyl carbonate, diisopropyl carbonate, diphenyl carbonate, ethylene carbonate and propylene carbonate: phosgene: halogenated formic acid esters such as methyl chloroformate, ethyl chloroformate and phenyl chloroformate. These compounds may be used alone, or may be used in combination of two or more thereof.

The polycarbonate polyol is synthesized subjecting a diol compound (I), a polyhydric alcohol (II) of tri- or more valence, and a compound (III) as a carbonyl component to a polycondensation reaction under general conditions. For example, the charged molar ratio of the diol compound (I) and the polyhydric alcohol (II) is preferably in the range of 50:50 to 99:1, and the charged molar ratio of the compound (III) as a carbonyl component to the diol compound (I) and the polyhydric alcohol (II) is preferably 0.2 to 2 equivalents to hydroxyl groups of the diol compound and the polyhydric alcohol.

The equivalent number (eq./mol) of hydroxyl groups existing in the polycarbonate polyol after the polycondensation reaction at the above-mentioned charged ratio is 3 or more, preferably 3 to 50, more preferably 3 to 20 on average in one molecule. When the above-mentioned equivalent number is in the above-mentioned range, a necessary amount of (meth)acrylate groups are formed through an esterification reaction as described later, and moderate flexibility is imparted to the polycarbonate (meth)acrylate resin. The terminal functional groups of the polycarbonate polyol are usually OH groups, but some of them may be carbonate groups.

The method for producing a polycarbonate polyol as described above is described in, for example. Japanese Patent Laid-open Publication No. 64-1726. The polycarbonate polyol can also be produced through an ester exchange reaction of a polycarbonate diol and a polyhydric alcohol of tri- or more valence as described in Japanese Patent Laid-open Publication No. 3-181517.

The molecular weight of the polycarbonate (meth)acrylate for use in the present invention is measured by GPC analysis, and the weight average molecular weight in terms of standard polystyrene is preferably 500 or more, more preferably 1,000 or more, further preferably more than 2,000. The upper limit of the weight average molecular weight of the polycarbonate (meth)acrylate is not particularly limited, but it is, for example, 100,000 or less, preferably 50,000 or less for performing control so that the viscosity does not become excessively high. The weight average molecular weight of the polycarbonate (meth)acrylate is further preferably more than 2,000 and 50,000 or less, especially preferably 5,000 to 20,000 for securing both scratch resistance and three-dimensional moldability.

The polycarbonate (meth)acrylates described above may be used alone, or may be used in combination of two or more thereof.

### (Polyfunctional (Meth)Acrylate)

The polyfunctional (meth)acrylate for use in the present invention is not particularly limited as long as it is a bi- or more functional (meth)acrylate. However, from the viewpoint of curability, the polyfunctional (meth)acrylate is preferably a tri- or more functional (meth)acrylate, more preferably a tri- to octa-functional (meth)acrylate, further preferably a tri- to hexa-functional (meth)acrylate. The unsaturated bond equivalent of (meth)acrylate is 500 or more from the viewpoint of three-dimensional moldability, and preferably 3000 or less from the viewpoint of curing, and more preferably 800 or more and 20000 or less, further preferably 1000 or more and 2000 or less. Here, the number of functional groups in the (meth)acrylate refers to the number of ethylenically unsaturated bonds ((meth)acryloyl groups) existing in one molecule. For example, the “bifunctional” means having two or more ethylenically unsaturated bonds ((meth)acryloyl groups) in the molecule. The unsaturated bond equivalent of the (meth)acrylate refers to a value obtained by dividing the molecular weight by the number of ethylenically unsaturated bonds ((meth)acryloyl groups) of the (meth)acrylate.

The polyfunctional (meth)acrylate may be either an oligomer or a monomer, but it is preferably a polyfunctional (meth)acrylate oligomer for improving three-dimensional moldability.

Preferred examples of the polyfunctional (meth)acrylate oligomer include urethane (meth)acrylate oligomers, epoxy (meth)acrylate oligomers, polyester (meth)acrylate oligomers and polyether (meth)acrylate oligomers.

Here, the urethane (meth)acrylate oligomer can be obtained by, for example, esterifying a polyurethane oligomer with a (meth)acrylic acid, the polyurethane oligomer being obtained by a reaction of a polyether polyol or a polyester polyol with a polyisocyanate. The epoxy (meth)acrylate oligomer can be obtained by, for example, reacting a (meth)acrylic acid with an oxirane ring of a relatively low-molecular-weight bisphenol-type epoxy resin or novolak-type epoxy resin to perform esterification. A carboxyl-modified epoxy (meth)acrylate oligomer obtained by partially modifying the epoxy (meth)acrylate oligomer with a dibasic carboxylic anhydrate can also be used. The polyester (meth)acrylate oligomer can be obtained by esterifying hydroxyl groups of a polyester oligomer, which is obtained by, for example, condensation of a polyvalent carboxylic acid and a polyhydric alcohol and has hydroxyl groups at both ends, with a (meth)acrylic acid, or esterifying hydroxyl groups at the ends of an oligomer, which is obtained by adding an alkylene oxide to a polyvalent carboxylic acid, with a (meth)acrylic acid. The polyether (meth)acrylate oligomer can be obtained by esterifying hydroxyl groups of a polyether polyol with a (meth)acrylic acid.

Further, preferred examples of the polyfunctional (meth)acrylate oligomer include high-hydrophobic polybutadiene (meth)acrylate oligomers having a (meth)acrylate group on the side chain of a polybutadiene oligomer, silicone (meth)acrylate oligomers having a polysiloxane bond on the main chain, and aminoplast resin (meth)acrylate oligomers obtained by modifying an aminoplast resin having many reactive groups in a small molecule.

Preferred examples of the polyfunctional (meth)acrylate monomer include ethylene glycol di(meth)acrylate, propylene glycol di(meth)acrylate, 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylolpropane tri(meth)acrylate, ethylene oxide-modified trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl)isocyanurate, propionic acid-modified dipentaerythritol penta(meth)acrylate, dipentaerythritol hexa(meth)acrylate, ethylene oxide-modified dipentaerythritol hexa(meth)acrylate and caprolactone-modified dipentaerythritol hexa(meth)acrylate.

The polyfunctional (meth)acrylate oligomers and polyfunctional (meth)acrylate monomers described above may be used alone, or may be used in combination of two or more thereof.

In the present invention, as long as the object of the present invention is not hindered, a monofunctional (meth)acrylate can be appropriately used in combination with the polyfunctional (meth)acrylate for the purpose of, for example, reducing the viscosity thereof. Preferred examples of the monofunctional (meth)acrylate include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, lauryl (meth)acrylate, stearyl (meth)acrylate and isobonyl (meth)acrylate. These monofunctional (meth) acrylates may be used alone, or may be used in combination of two or more thereof.

### (Ultraviolet Absorber)

Preferably, the electron beam-curable resin composition for forming the surface protective layer contains an ultraviolet absorber for obtaining excellent weather resistance, and an effect of suppressing discoloration of the resin film in long-term use. The ultraviolet absorber is not particularly limited, and preferred examples thereof include triazine-based ultraviolet absorbers, benzotriazole-based ultraviolet absorbers, benzophenone-based ultraviolet absorbers, salicylic acid phenyl ester-based ultraviolet absorbers and acrylonitrile-based ultraviolet absorbers. Among them, triazine-based ultraviolet absorbers are preferable. Specific examples of the triazine-based ultraviolet absorber are as described above. These ultraviolet absorbers may be used alone, or may be used in combination of two or more thereof.

The content of the ultraviolet absorber in the electron beam-curable resin composition is preferably 0.1 to 10 parts by mass, more preferably 0.1 to 5 parts by mass, further preferably 0.1 to 2 parts by mass based on 100 parts by mass of the ionizing radiation-curable resin. When the content of the ultraviolet absorber is in the above-mentioned range, excellent weather resistance and an effect of suppressing discoloration of the resin film are obtained, excellent hard coat characteristics are obtained while crosslinking hindrance does not occur, and bleed-out etc. can be suppressed.

### (Light Stabilizer)

Preferably, the electron beam-curable resin composition for forming the surface protective layer contains a light stabilizer as desired for further improving weather resistance. The light stabilizer is preferably a hindered amine-based light stabilizer (HALS) as described above.

An electron beam-reactive hindered amine-based light stabilizer, which is reactive with an electron beam-curable resin, and hence has an electron beam-reactive group in the molecule, is also preferable. When such an electron beam-reactive hindered amine-based light stabilizer is used, scratch resistance can be improved while crosslinking hindrance does not occur, and breed-out can be reduced, so that deterioration of properties due to bleed-out can be effectively suppressed. The electron beam-reactive group is preferably a functional group having an ethylenic double bond, such as a (meth)acryloyl group, a vinyl group or an allyl group.

Preferred examples of the light stabilizer include 1,2,2,6,6-pentamethyl-4-piperidinyl methacrylate (manufactured by BASF SE, trade name “SANOL LS-3410”) or (manufactured by Hitachi Chemical Company, Ltd., trade name “FA-711MM”), and 2,2,6,6-tetramethyl-4-piperidinyl methacrylate (manufactured by Hitachi Chemical Company, Ltd., trade name “FA-712HM”). These light stabilizers may be used alone, or may be used in combination of two or more thereof.

The content of the light stabilizer in the electron beam-curable resin composition is preferably 0.1 to 15 parts by mass, more preferably 0.1 to 10 parts by mass based on 100 parts by mass of the ionizing radiation-curable resin. When the content of the light stabilizer is in the above-mentioned range, excellent weather resistance is obtained, and therefore occurrence of breakage and peeling due to photodegradation in the surface protective layer can be suppressed, so that excellent scratch resistance is obtained while crosslinking hindrance does not occur, and occurrence of bleed-out etc. can be suppressed.

### (Various Additives)

The electron beam-curable resin composition for forming the surface protective layer may contain various additives according to desired physical properties as long as the properties of the composition are not hindered. Examples of the additives include abrasion resistance improvers, polymerization inhibitors, crosslinkers, infrared absorbers, antistatic agents, adhesiveness improvers, leveling agents, thixotropy imparting agents, coupling agents, plasticizers, antifoaming agents, fillers, solvents and colorants.

The thickness of the surface protective layer is normally about 1 to 20 μm, preferably 3 to 15 μm. When the thickness of the surface protective layer is in the above-mentioned range, excellent weather resistance and retainability thereof, scratch resistance and transparency are obtained, and excellent three-dimensional moldability is also obtained.

### <<Primer Layer>>

The primer layer is a layer that is preferably provided between the resin film and the surface protective layer as shown in FIG. 2 for improving interlayer adhesion between the resin film and the surface protective layer. When provided, the primer layer serves as a stress releasing layer for the surface protective layer, and thus can be expected to exhibit an effect of suppressing breakage of the surface protective layer due to deterioration of weather resistance.

The primer layer may be formed from a primer layer forming resin composition containing a resin that improves adhesion between both layers facing each other with the primer layer sandwiched therebetween, and the resin is not particularly limited, but for example, one of resins such as polyurethane-based resin, polyester-based resin, acryl-based resin, vinyl acetate-based resin, vinyl chloride-vinyl acetate-based copolymer resin, cellulose-based resin, chlorinated polyethylene and chlorinated polypropylene, or a mixture of two or more thereof is preferably used.

The primer layer forming resin composition is preferably a resin composition containing a polymer polyol and a curing agent, and more specifically, a two-liquid curable urethane resin with a curing agent added to one of vinyl chloride-vinyl acetate copolymer-based, polyester-based, urethane-based, acryl-based, polyether-based and polycarbonate-based polymer polyols, or mixture thereof just before use is preferable.

As the polymer polyol, an acryl-based polymer polyol or a polyester-based polymer polyol is preferable, and an acryl-based polymer polyol is more preferable.

Preferred examples of the acryl-based polymer polyol include those with a plurality of hydroxyl groups introduced by copolymerizing a hydroxyacrylate such as 2-hydroxyethyl acrylate or 2-hydroxy-3-phenoxypropyl acrylate with a (meth)acrylic acid alkyl ester such as ethyl (meth)acrylate. As the polyester-based polymer polyol, for example, poly(ethylene adipate), poly(butylene adipate), poly(neopentyl adipate), poly(hexamethylene adipate), poly(butylene azelate), poly(butylene sebacate), polycaprolactone or the like is used.

In the present invention, it is preferable to use a mixture of the acryl-based polymer polyol and urethane resin as the primer layer forming resin composition. In this case, the blending ratio (mass ratio) of the acryl-based polymer polyol and urethane resin is preferably 40:60 to 95:5, more preferably 60:40 to 90:10. When the blending ratio is in the above-mentioned range, excellent adhesion is obtained.

The curing agent is preferably a polyvalent isocyanate, and for example, aromatic isocyanates such as 2,4-tolylene diisocyanate, xylene diisocyanate, naphthalene diisocyanate or 4,4′-diphenylmethane diisocyanate; and an aliphatic (or cycloaliphatic) isocyanates such as 1,6-hexamethylene diisocyanate, 2,2,4-trimethylhexamethylene diisocyanate, isophorone diisocyanate, hydrogenated tolylene diisocyanate, hydrogenated diphenylmethane diisocyanate can be used, or adducts or polymers of the above-mentioned various isocyanates, for example an adduct of tolylene diisocyanate, a tolylene diisocyanate trimer and the like can be used. These curing agents may be used alone, or may be used in combination of two or more thereof.

In the present invention, the glass transition temperature Tg of the polymer polyol (uncured state) to be used as a polyurethane-based two-liquid curable resin is preferably 65° C. or higher, and the upper limit of the glass transition temperature Tg is not particularly limited, but it is normally about 110° C., and the transition temperature is preferably in the range of 70 to 100° C. When the glass transition temperature Tg is in the above-mentioned range, excellent adhesion is obtained.

For formation of the primer layer, a resin reactive with the electron beam-curable resin to be used in the surface protective layer may be used. Accordingly, interlayer adhesion between the primer layer and the surface protective layer is improved. Particularly, the adhesion is not deteriorated even after a strict weather resistance test, and therefore the laminating film of the present invention has high durability, and hence maintains adhesion even when used outdoors for a long period of time.

At the time when the surface protective layer is provided on the primer layer, the surface of the primer layer can be subjected to a treatment such as a corona discharge treatment, a plasma treatment, a chromium oxidation treatment, a flame treatment, a hot air treatment or an ozone/ultraviolet treatment for improving adhesion between the primer layer and the surface protective layer.

### (Ultraviolet Absorber)

Preferably, the primer layer contains an ultraviolet absorber for obtaining excellent weather resistance, and an effect of suppressing discoloration of the resin film. The ultraviolet absorber is not particularly limited, and preferred examples thereof include triazine-based ultraviolet absorbers, benzotriazole-based ultraviolet absorbers, benzophenone-based ultraviolet absorbers, salicylic acid phenyl ester-based ultraviolet absorbers and acrylonitrile-based ultraviolet absorbers. Among them, triazine-based ultraviolet absorbers are preferable. Specific examples of the triazine-based ultraviolet absorber are as described above. These ultraviolet absorbers may be used alone, or may be used in combination of two or more thereof.

The content of the ultraviolet absorber in the primer layer is preferably 0.1 to 50 parts by mass, more preferably 1 to 40 parts by mass, further preferably 5 to 40 parts by mass, especially preferably 5 to 30 parts by mass based on 100 parts by mass of the resin for forming the primer layer. When the content of the ultraviolet absorber is in the above-mentioned range, excellent weather resistance and an effect of suppressing discoloration of the resin film are obtained, excellent hard coat characteristics are obtained while crosslinking hindrance does not occur, and occurrence of bleed-out etc. can be suppressed.

### (Light Stabilizer)

Preferably, the primer layer contains a light stabilizer as desired for further improving weather resistance. The light stabilizer is preferably a hindered amine-based light stabilizer (HALS) as described above. An electron beam-reactive hindered amine-based light stabilizer, which is reactive with an electron beam-curable resin, and hence has an electron beam-reactive group in the molecule, is also preferable. Specific examples of the light stabilizer are as described above. These light stabilizers may be used alone, or may be used in combination of two or more thereof.

The content of the light stabilizer in the primer layer is preferably 0.05 to 15 parts by mass, more preferably 0.5 to 12 parts by mass, further preferably 1 to 10 parts by mass, especially preferably 3 to 10 parts by mass based on 100 parts by mass of the resin for forming the primer layer. When the content of the light stabilizer is in the above-mentioned range, excellent weather resistance is obtained, and therefore occurrence of breakage and peeling due to photodegradation in the surface protective layer can be suppressed, so that excellent scratch resistance is obtained while crosslinking hindrance does not occur, and bleed-out etc. does not occur.

The primer layer may contain inorganic particles such as silica particles for preventing blocking in the production process. The silica particles are not particularly limited as long as they can be used as a matting agent. The particle size of the silica particle is normally about 1 to 7 μm, preferably 5 μm or less. When the particle size of the silica particle is 5 μm or less, the problem does not occur that cracks are generated with the inorganic particle as an origin. The particle shape is preferably a spherical shape.

For the type of the silica particles, a previously known type of silica particles can be used irrespective of whether they are treated or untreated, and one type of silica particles may be used, or two or more type of silica particles may be used in combination.

The blending amount of silica particles is preferably 5 to 25 parts by mass based on 100 parts by mass of the resin component for forming the primer layer. When the content of silica particles is in the above-mentioned range, transparency can be secured while the coating properties of the resin composition for forming the primer layer are retained.

The thickness of the primer layer is not particularly limited as long as the effect of the present invention is exhibited, but it is preferably in the range of 0.5 to 10 p.m. more preferably in the range of 1 to 5 μm for obtaining sufficient adhesiveness.

### <<Adhesive Layer>>

The adhesive layer is provided as necessary for improving adhesion with a resin base as described later. The adhesive layer is provided on a surface of the resin film on a side opposite to a surface that is provided with the surface protective layer, i.e. the adhesive layer is provided on a surface that is in contact with the resin base.

Preferred examples of the adhesive layer include layers formed of a heat-sensitive adhesive or a pressure-sensitive adhesive. The adhesive layer is preferably a heat seal layer that exhibits adhesion with the resin base when heated or pressurized as necessary. The resin that forms the adhesive layer may be appropriately selected according to a resin that forms the resin base, and preferred examples thereof may include at least one resin selected from acrylic resin, vinyl chloride resin, vinyl acetate resin, vinyl chloride-vinyl acetate copolymer resin, styrene-acryl copolymer resin, polyester resin and polyamide resin.

The thickness of the adhesive resin is preferably 30 μm or less, more preferably about 0.1 to 20 μm, further preferably about 0.5 to 8 μm for obtaining excellent adhesiveness with the resin base.

### <<Method for Producing Laminating Film>>

The method for producing a laminating film for use in organic glass of the present invention includes, sequentially, the steps of: (I) forming an uncured resin layer on a resin film containing a triazine-based ultraviolet absorber by applying an electron beam-curable resin composition containing a polycarbonate (meth)acrylate and a polyfunctional (meth)acrylate at a mass ratio of 98:2 to 50:50; and (II) forming a surface protective layer by irradiating the uncured resin layer with an electron beam to cure the uncured resin layer.

### (Step (I))

The step (I) is a step of forming an uncured resin layer on a resin film containing a triazine-based ultraviolet absorber by applying an electron beam-curable resin composition containing a polycarbonate (meth)acrylate and a polyfunctional (meth)acrylate at a predetermined mass ratio.

The electron beam-curable resin composition can be applied by a known method such as gravure coating, bar coating, roll coating, reverse roll coating or comma coating, preferably gravure coating.

In the present invention, it is preferable that before the electron beam-curable resin composition is applied, the primer layer is formed on the resin film by applying a primer layer forming resin composition. The primer layer forming resin composition is applied by the same known method as in the case of the electron beam-curable resin composition, preferably gravure coating.

### (Step (II))

The step (II) is a step of forming a surface protective layer by irradiating the uncured resin layer, which is formed in the step (I), with an electron beam to cure the uncured resin layer.

The condition for application of an electron beam can be appropriately selected according to the resin composition to be used and the thickness of the layer, but normally it is preferable to cure the ionizing radiation-curable resin composition layer at an accelerating voltage of about 70 to 300 kV. In application of an electron beam, the transmission capacity increases as the accelerating voltage becomes higher, and therefore in the case where one that is discolored or degraded by an electron beam is used as the resin film, the accelerating voltage is selected in such a manner that the transmission depth of the electron beam is substantially equal to the thickness of the resin layer. Accordingly, excessive application of the electron beam to the resin film can be suppressed, so that degradation of the resin film by an excessive electron beam can be minimized.

The irradiation dose is preferably a dose which ensures that the crosslinking density of a semicured resin layer is saturated. The irradiation dose is selected normally within the range of 5 to 300 kGy (0.5 to 30 Mrad), preferably within the range of 10 to 70 kGy (1 to 7 Mrad).

The electron beam source is not particularly limited, and various electron beam accelerators can be used, such as those of Cockcroft-Walton type, Van de Graaff type, resonance transformer type, insulated core transformer type, linear type, dynamitron type, and high frequency type.

In the case where the resin composition contains a solvent, it is preferable that after application of the resin composition, the applied layer is heated and dried by a hot air dryer, and then irradiated with an electron beam so that the crosslinking reaction of the resin composition is not hindered.

Normally after the surface protective layer is formed, the adhesive layer can be formed in the following manner: a coatable form such as a solution or emulsion of one or more resins selected from the above-mentioned resins is applied and dried by the same known method as in the case of the electron beam-curable resin composition.

### [Organic Glass]

The organic glass of the present invention has a resin base on the resin film side of the above-mentioned laminating film for use in organic glass of the present invention.

The organic glass of the present invention will be described with reference to the drawings. FIG. 3 is a schematic view showing a cross section of one example of a preferred aspect of the organic glass of the present invention. In FIG. 3 is shown an organic glass which includes a laminating film 10 including a primer layer 2 between a resin film 1 and a surface protective layer 3, and including an adhesive layer 4 on a surface of the resin film 1 on a side opposite to a surface provided with the surface protective layer 3; and a resin base 5 disposed in contact with the adhesive layer 4, i.e. disposed on the resin film 1 side.

The resin for a base substrate, which forms the resin base, is preferably one having high transparency, and specifically, a resin identical to the resin that forms the resin film is preferable. From the viewpoint of transparency, polycarbonate resin, acryl resin, polyester resin are preferable, and further, when impact resistance etc. is taken into consideration, polycarbonate resin is preferable as in the case of the resin that forms the resin film.

Normally, the thickness of the resin base is preferably 1 to 20 mm, more preferably 2 to 10 mm. When the thickness of the resin base 5 is 1 mm or more, practical strength such as rigidity of the base substrate becomes sufficient. When the thickness of the resin base 5 is 20 mm or less, processability is improved. The shape of the resin base may be appropriately selected according to the use of the organic glass, and is not limited to a plate shape.

### [Method for Producing Organic Glass]

The organic glass of the present invention can be produced using the laminating film for use in organic glass of the present invention, and as the production method, for example, an injection molding method such as a thermoject molding method (an simultaneous injection molding with lamination with a heating vacuum molding process combined with an injection molding process), an insert molding method or an in-mold molding method: an extrusion molding method: an injection press molding method: or the like is preferably employed.

In an injection molding method such as a thermoject molding method, an insert molding method or an in-mold molding method, an organic glass can be produced by injecting a resin for a base substrate such as polycarbonate resin to the back surface of a laminating film for use in organic glass. The organic glass thus obtained may have a variety of curved surfaces, and is therefore suitably used for automobile window glass etc. In the in-mold molding method, a laminating film for use in organic glass is sandwiched in a mold of an injection molding machine without being heated, and a resin for a base substrate is injected, whereby an organic glass can be obtained by laminating the laminating film for use in organic glass using heat from the injected resin, etc.

In the extrusion molding method, a laminating film for use in organic glass can be laminated by press-bonding the back surface thereof to a resin for a base substrate such as polycarbonate resin using a roll etc. immediately after the resin for a base substrate is discharged from a die or after the discharged resin is cooled.

Further, in the injection press molding method, a laminating film for use in organic glass is disposed in an opened mold beforehand, a molten resin is injected into a mold space opened by a compression stroke, and the mold is closed after completion of filling the mold, and compressed with a clamping force to laminate the laminating film to an organic glass.

After the laminating film for use in organic glass is attached to the organic glass, the organic glass may be heating-molded to produce automobile window glass, etc.

Among the above-mentioned methods, an injection molding method, i.e. a thermoject molding method, an insert molding method or an in-mold molding method is suitably used for actively exploiting excellent properties, i.e. excellent transparency, excellent weather resistance and scratch resistance and excellent three-dimensional moldability, of the laminating film for use in organic glass of the present invention. Hereinafter, these molding methods will be described more in detail, but the method for producing an organic glass is not limited to the examples shown below.

The method for producing an organic glass by a thermoject molding method is a method including, sequentially, the steps of: (A) heating the laminating film for use in organic glass of the present invention from the resin film side by a heating platen with the resin film side of the laminating film made to face the inside of a mold, (B) preliminarily molding the heated laminating film so as to follow the shape of the inside of the mold, bringing the laminating film into close contact with the inner surface of the mold, and clamping the mold: (C) injecting a resin for a base substrate into the mold; and (D) taking out an organic glass from the mold after the resin for a base substrate is cooled.

In the steps (A) and (B), the temperature at which the laminating film for use in organic glass of the present invention is heated is preferably equal to or higher than the vicinity of the glass transition temperature of the resin film and lower than the melting temperature (or melting point) of the resin film. Normally, a temperature in the vicinity of the glass transition temperature is more preferable. The vicinity of the glass transition temperature means a temperature within the range of glass transition temperature ± about 5° C. For example, when polycarbonate resin is selected as a resin that forms the resin film, normally it is preferable to heat the laminating film at about 140 to 170° C., and when acrylic resin or polyester resin is selected, normally it is preferable to heat the laminating film at 70 to 130° C.

In the step (C), the resin for a base substrate is melted, and injected into a cavity to obtain a laminate with the laminating film integrated with the resin for a base substrate. The resin for a base substrate may be melted by heating, and the heating temperature depends on the resin for a base substrate, but is normally about 180 to 320° C. The laminate thus obtained is cooled, and then taken out from the mold to obtain the organic glass of the present invention.

The method for producing an organic glass by an insert molding method is a method including, sequentially, the steps of: (a) disposing a support layer on the resin film side of the laminating film for use in organic glass of the present invention; (b) performing vacuum molding with the support layer side of the laminating film disposed on the mold side; (c) injecting a resin for a base substrate into the mold in such a manner that the resin for a base substrate is injected to the support layer side of the laminating film with a support layer after vacuum molding; and (d) taking out an organic glass from the mold after the resin for a base substrate is cooled.

Preferred examples of the material to be used in the support layer in the step (a) include ABS resin, polyolefin resin, styrene resin, (meth)acrylic resin, vinyl chloride resin and polycarbonate resin. The material to be used in the support layer is preferably the same material as that of the resin for a base substrate for improving adhesiveness with the resin for a base substrate, and for example, when polycarbonate resin is employed as the resin for a base substrate, the material to be used in the support layer is preferably polycarbonate resin.

Since the support layer is laminated for reinforcing the laminating film, and retaining the form of the integrated product, the thickness of the support layer is preferably 0.1 to 1.0 mm.

In the step (b), the laminating film for use in organic glass of the present invention may be disposed with the surface protective layer made to face the cavity (concave) side of the injection molding machine as in the case of the thermoject molding method, or may be disposed with the surface protective layer made to face the core (convex) side of the injection molding machine. Alternatively, the organic laminating film may be disposed with the surface protective layer made to face both the cavity (concave) side and the core (convex) side.

The method for producing an organic glass by an in-mold molding method is a method including, sequentially, the steps of: (a) disposing the laminating film for use in organic glass of the present invention in a mold; (β) injecting a resin for a base substrate into the mold; and (γ) taking out an organic glass from the mold after the resin for a base substrate is cooled. In this method, the laminating film for use in organic glass may be evacuated before the resin for a base substrate is injected into the mold in the step (β). If air exists in gaps generated in the space between the mold and the laminating film, failures occur such as generation of creases during molding.

According to this method, an organic glass can be produced by integrally bonding the laminating film to the surface of the resin for a base substrate.

### EXAMPLES

The present invention will now be described further in detail by way of examples, but the present invention is in no way limited to these examples.

### (Evaluation Method)

### (1) Three-Dimensional Moldability

Organic glasses obtained in examples and comparative examples were evaluated in accordance with the following evaluation criteria.

⊚: On the maximum-stretched area (area with an elongation of 100%) of the laminating film for use in organic glass, external appearance defects such as breakage and whitening were not observed on the external appearance.
◯: Slight breakage, whitening and the like were observed on the maximum-stretched area of the laminating film for use in organic glass, but breakage, whitening and the like were not observed on the medium-stretched area (area with an elongation of 50%).
Δ: Breakage, whitening and the like were observed on the maximum-stretched area of the laminating film for use in organic glass, but breakage, whitening and the like were not observed on the less-stretched area (area with an elongation of 25%).
x: Significant external appearance defects such as breakage and whitening were observed in the laminating film for use in organic glass.

### (2) Scratch Resistance

The organic glass obtained in each of examples and comparative examples was scraped back and forth five times under a load of 300 g/cm² using a steel wool (“Bonstar #0000 (trade name)” manufactured by NIHON STEEL WOOL Co., Ltd.), and its external appearance was evaluated by visual inspection. Evaluation criterial are as follows.

◯: There was almost no change in external appearance.
Δ: There were slight scratches and a slight gloss change on the external appearance.
x: There were scratches and a gloss change on the external appearance.

### (3) Weather Resistance

The organic glass obtained in each of examples and comparative examples was set in METAL WEATHER (manufactured by DAYPLA WINTES CO., LTD.), and a weather resistance test was conducted in the following manner: the organic glass was left standing under a light condition (illuminance: 60 mW/cm², black panel temperature: 63° C., humidity in layer: 50% RH) for 20 hours, under a condensation condition (illuminance: 0 mW/cm², black panel temperature: 30° C. humidity in layer: 98% RH) for 4 hours, and under a water spray condition (10 seconds before and after the condensation condition) for 500 hours. After the weather resistance test was conducted, the organic glass was held under the condition of 25° C. and 50% RH for 2 days, followed by evaluating the external appearance of the organic glass by visual inspection for cracks, yellowing and the like in accordance with the following criteria.

### (External Appearance of Organic Glass Surface)

◯: There was no change in external appearance.
Δ: There were slight cracks on the surface.
x: There were countless cracks on the surface.

### (Discoloration of Resin Film)

◯: There was no change in external appearance.
Δ: Slight yellowing was observed.
x: Significant yellowing was observed.

### (4) Color Difference

For laminating films for use in organic glass obtained in examples and comparative examples, a difference ΔE between the color difference 7 days after completion of each curing reaction and the color difference of the resin film was measured, and the value of ΔE was evaluated in accordance with the following criteria

### ◯: ΔE≦1.0

### Δ: 1.0<ΔE≦3.0

### x: ΔE>3.0

### (5) Evaluation on Bleed-Out

The organic glass obtained in each of examples and comparative examples was stored under warm water at 40° C. for 24 hours, the surface of the organic glass was then touched with a finger, and evaluated in accordance with the following criteria.

◯: The surface was not sticky at all.
Δ: The surface was slightly sticky due to bleed-out of an ultraviolet absorber etc., but there was no problem in practical use.
x: The surface was significantly sticky due to bleed-out.

### (6) Chemical Resistance

Several drops of a 10% aqueous ethanol solution was dropped by a dropper to the organic glass obtained in each of examples and comparative examples, the organic glass was covered with a watch glass, and left standing for 24 hours, the dropped aqueous ethanol solution was then wiped off, and the external appearance was evaluated by visual inspection. Evaluation criterial are as follows.

◯: There was almost no change in external appearance.
x: Dissolution, discoloration and a gloss change were observed on the external appearance.

### Example 1

A 100 μm-thick acrylic resin (polymethyl methacrylate resin) film containing 1 part by mass of a triazine-based ultraviolet absorber based on 100 parts by mass of acrylic resin was provided as a resin film, a primer layer forming resin composition as described below was applied to one surface of the resin film in such a manner that the thickness would be 3 μm, an electron beam-curable resin composition for formation of a surface protective layer as described below was applied thereto in such a manner that the thickness would be 10 μm, and an electron beam was then applied under the condition of 165 kV-50 kGy to cure the electron beam-curable resin composition, thereby obtaining a laminating film for use in organic glass.

The obtained laminating film for use in organic glass was arranged with the resin film thereof made to face the inside of a mold, the laminating film was heated at a heating platen temperature of 350° C., so that the laminating film had a temperature of 100° C., the laminating film was preliminarily molded so as to follow the shape of the inside of the mold, and brought into close contact with the inner surface of the mold, and the mold was clamped. As the mold, one having a tray-like shape with a size of 80 mm square, a drawing depth of 3 mm and a corner radius of 11 R was used. Polycarbonate resin (“Panlite L-1250Z (trade name)” manufactured by Teijin Chemicals Ltd.) was provided as a resin for a base substrate, and this resin was melted at 310° C., and then injected into a cavity. Thereafter, an organic glass in which the resin base and the laminating film for use in organic glass were laminated was taken out from the mold at 90° C.

The obtained organic glass was evaluated in accordance with the above-mentioned method. The results are shown in Table 1.

### (Primer Layer Forming Resin Composition)

Polyurethane two-liquid curable resin (a composition containing an acryl polymer polyol and xylylene diisocyanate as a curing agent with the NCO equivalent being equal to the OH equivalent; glass transition temperature Tg (polyol is uncured): 100° C.): 80 parts by mass

Urethane resin: 20 parts by mass
Triazine-based ultraviolet absorber: 10 parts by mass (“TINUVIN 479 (trade name)” manufactured by BASF SE,
2-(2-hydroxy-4-[1-octyloxycarbonylethoxy]phenyl)-4,6-bis(4-phenylphenyl)-1,3,5-triazine)
Hindered amine-based light stabilizer: 10 parts by mass (“TINUVIN 123 (trade name)” manufactured by BASF SE, decanedioic acid-bis(2,2,6,6-tetramethyl-1-(octyloxy)-4-piperidinyl) ester)

### (Surface Protective Layer Forming Resin Composition)

Difunctional polycarbonate acrylate (weight average molecular weight: 10,000): 94 parts by mass
Hexafunctional urethane acrylate (weight average molecular weight: 6,000): 6 parts by mass
Triazine-based ultraviolet absorber: 5 parts by mass (“TINUVIN 479 (trade name)” manufactured by BASF SE,
2-(2-hydroxy-4-[1-octyloxycarbonylethoxy]phenyl)-4,6-bis(4-phenylphenyl)-1,3,5-triazine)
Electron beam-reactive hindered amine-based light stabilizer: 5 parts by mass (“SANOL LS-3410 (trade name)” manufactured by BASF SE, 1,2,2,6,6-pentamethyl-4-piperidinyl methacrylate)

### Examples 2 to 8 and Comparative Examples 1 to 5

Except that the resin film, the primer layer forming resin composition and the surface protective layer forming resin composition in Example 1 were changed as shown in Table 1, the same procedure as in Example 1 was carried out to obtain an organic glass. The obtained organic glass was evaluated in accordance with the above-mentioned method. The results are shown in Table 1.

TABLE 1

| | | | Examples | | | | | | | | Comparative Examples | | | | |
|---|---|---|---|---|---|---|---|---|---|---|---|---|---|---|---|
| | | | 1 | 2 | 3 | 4 | 5 | 6 | 7 | 8 | 1 | 2 | 3 | 4 | 5 |
| Base | Resin | A *¹ | 100 | 100 | 100 | 100 | 100 | 100 | — | 100 | 100 | 100 | 100 | 100 | 100 |
| material | | B *² | — | — | — | — | — | — | 100 | — | — | — | — | — | — |
| | Additives | A *³ | 1 | 1 | 1 | 1 | 1 | 1 | 1 | 1 | — | — | 1 | 1 | 1 |
| | | B *⁴ | — | — | — | — | — | — | — | — | 1 | — | — | — | — |
| | | C *⁵ | — | — | — | — | — | — | — | — | — | 1 | — | — | — |
| Primer | Resin | A *⁶ | 100 | 100 | 100 | 100 | 100 | — | 100 | — | 100 | 100 | 100 | 100 | 100 |
| | | B *⁷ | — | — | — | — | — | 100 | — | — | — | — | — | — | — |
| | Additives | A *⁸ | 10 | 10 | 10 | 10 | 10 | 10 | 10 | — | 10 | 10 | 10 | 10 | 10 |
| | | B *⁹ | 10 | 10 | 10 | 10 | 10 | 10 | 10 | — | 10 | 10 | 10 | 10 | 10 |
| Protective | Resin | A *¹⁰ | 94 | 60 | 94 | 85 | — | 94 | 94 | 94 | 94 | 94 | 100 | 40 | — |
| layer | | B *¹¹ | — | — | — | — | 95 | — | — | — | — | — | — | — | — |
| | | C *¹² | 6 | 40 | — | 10 | — | 6 | 6 | 6 | 6 | 6 | — | 60 | — |
| | | D *¹³ | — | — | 6 | 5 | 5 | — | — | — | — | — | — | — | — |
| | | E *¹⁴ | — | — | — | — | — | — | — | — | — | — | — | — | 100 |
| | Additives | A *¹⁵ | 5 | 5 | 5 | 5 | 5 | 5 | 5 | 5 | 5 | 5 | 5 | 5 | 5 |
| | | B *¹⁶ | 5 | 5 | 5 | 5 | 5 | 5 | 5 | 5 | 5 | 5 | 5 | 5 | 5 |

| | | | | | | | | | | | | | | |
|---|---|---|---|---|---|---|---|---|---|---|---|---|---|---|
| Evaluation | Three-dimensional | ⊙ | ◯ | ⊙ | ◯ | ◯ | ⊙ | ⊙ | ⊙ | ⊙ | ⊙ | ◯ | X | ◯ |
| results | moldability | | | | | | | | | | | | | |
| | Scratch resistance | ⊙ | ◯ | ◯ | ⊙ | ◯ | ⊙ | ⊙ | ⊙ | ⊙ | ⊙ | X | Δ | X |
| | Weather resistance | ◯ | ◯ | ◯ | ◯ | ◯ | ◯ | ◯ | ◯ | ◯ | ◯ | ◯ | ◯ | Δ |
| | (surface external | | | | | | | | | | | | | |
| | appearance) | | | | | | | | | | | | | |
| | Weather resistance | ⊙ | ⊙ | ⊙ | ⊙ | ⊙ | ⊙ | ◯ | ◯ | ⊙ | ⊙ | ◯ | ◯ | ◯ |
| | (discoloration) | | | | | | | | | | | | | |
| | Color difference | ◯ | ◯ | ◯ | ◯ | ◯ | ◯ | ◯ | ◯ | X | X | ◯ | ◯ | ◯ |
| | Bleed-out | ◯ | ◯ | ◯ | ◯ | ◯ | ◯ | ◯ | ◯ | ◯ | ◯ | ◯ | ◯ | ◯ |
| | Chemical resistance | ◯ | ◯ | ◯ | ◯ | ◯ | ◯ | ◯ | ◯ | ◯ | ◯ | ◯ | ◯ | ◯ |

[Note]
*¹ acrylic resin (polymethyl methacrylate resin)
*² polyester resin (polyethylene terephthalate resin)
*³ 2-(2-hydroxy-4-[1-octyloxycarbonylethoxy]phenyl)-4,6-bis(4-phenylphenyl)-1,3,5-triazine (manufactured by BASF SE, trade name “TINUVIN 479”)
*⁴ isooctyl-3-(3-(2H-benzotriazole-2-yl)-5-tertiary butyl-4-hydroxyphenyl propionate (manufactured by BASF SE, trade name “TINUVIN 384-2”)
*⁵ 2-(2H-benzotriazole-2-yl)-4,6-bis (1-methyl-1-phenylethyl)phenol (manufactured by BASF SE, trade name “TINUVIN 900”)
*⁶ mixture of 80 parts by mass of polyurethane two-liquid curable resin (a composition containing an acryl polymer polyol and xylylene diisocyanate as a curing agent with the NCO equivalent being equal to the OH equivalent; glass transition temperature Tg (polyol is uncured): 100° C.) and 20 parts by mass of urethane resin
*⁷ (meth)acryl/urethane copolymer resin (acryl/urethane ratio (weight ratio) = 3/7)
*⁸ 2-(2-hydroxy-4-[1-octyloxycarbonylethoxy]phenyl)-4,6-bis(4-phenylphenyl)-1,3,5-triazine (trade name “TINUVIN 479” manufactured by BASF SE)
*⁹ decanedioic acid-bis(2,2,6,6-tetramethyl-1-(octyloxy)-4-piperidinyl) ester, reaction product of 1,1-dimethylethyl hydroperoxide and octane (“TINUVIN 123 (trade name)” manufactured by BASF SE)
*¹⁰ electron beam-curable resin A; difunctional polycarbonate acrylate (weight average molecular weight: 10,000, unsaturated bond equivalent: 5,000)
*¹¹ electron beam-curable resin B; hexafunctional polycarbonate acrylate (weight average molecular weight; 6,000, unsaturated bond equivalent: 1,000)
*¹² electron beam-curable resin C; hexafunctional urethane acrylate oligomer (weight average molecular weight: 6,000, unsaturated bond equivalent: 1,000)
*¹³ electron beam-curable resin D; hexafunctional urethane acrylate oligomer (weight average molecular weight: 10,000, unsaturated bond equivalent: 1,667)
*¹⁴ Polyurethane two-liquid curable resin (a composition containing an acryl polymer polyol and xylylene diisocyanate as a curing agent with the NCO equivalent being equal to the OH equivalent; glass transition temperature Tg (polyol is uncured): 100° C.)
*¹⁵ 2-(2-hydroxy-4-[1-octyloxycarbonylethoxy]phenyl)-4,6-bis(4-phenylphenyl)-1,3,5-triazine (trade name “TINUVIN 479” manufactured by BASF SE)
*¹⁶ 1,2,2,6,6-pentamethyl-4-piperidinyl rnethacrylate (“SANOL LS-3410 (trade name)” manufactured by BASF SE)

The organic glasses obtained in Examples 1 to 8 were confirmed to have excellent effects in all evaluation items, and had excellent transparency. On the other hand, in Comparative Examples 1 and 2 where the ultraviolet absorber contained in the resin film was a benzotriazole-based ultraviolet absorber, the laminating film for use in organic glass with the surface protective layer cured by application of an electron beam was significantly discolored, resulting in impairment of the commercial value. It was confirmed that in Example 3 where a polyfunctional (meth)acrylate was not used as a resin component of the electron beam-curable resin composition for formation of a surface protective layer, scratch resistance was low. It was confirmed that in Comparative Example 4 in which the content of polycarbonate acrylate resin was low, satisfactory three-dimensional moldability was not obtained, and scratch resistance was slightly reduced. It was confirmed that in Comparative Example 5 where a thermosetting resin was used for formation of the surface protective layer, scratch resistance was low, and weather resistance was slightly reduced.

### INDUSTRIAL APPLICABILITY

The laminating film for use in organic glass of the present invention exhibits excellent transparency with little discoloration of a resin film after application of an electron beam, and exhibits excellent weather resistance and scratch resistance, and excellent three-dimensional moldability. Therefore, the laminating film for use in organic glass of the present invention is suitably used in front doors and exterior materials for general dwelling houses, floor materials and structure exteriors such as external walls and roofs for public facilities, or structure exteriors for automobiles, trains, vessels, aircrafts, industrial machineries and heavy machineries, particularly in applications in which inorganic glasses have been heretofore used, such as window materials and sunroof materials, and further, head lamps and head lamp covers.

### DESCRIPTION OF REFERENCE SIGNS

1: Resin film
2: Primer layer
3: Surface protective layer
4: Adhesive layer
5: Resin base
10: Laminating film for use in organic glass
11: Organic glass

1. A laminating film for use in organic glass comprising a resin film containing a triazine-based ultraviolet absorber, and a surface protective layer, the surface protective layer including a cured product of an electron beam-curable resin composition containing a polycarbonate (meth)acrylate and a polyfunctional (meth)acrylate at a mass ratio of 98:2 to 50:50.

2. The laminating film for use in organic glass according to claim 1, comprising a primer layer between the resin film and the surface protective layer.

3. The laminating film for use in organic glass according to claim 1, wherein the polyfunctional (meth)acrylate is tri- or more functional.

4. The laminating film for use in organic glass according to claim 1, wherein the polycarbonate (meth)acrylate has a weight average molecular weight of more than 2000 and 50000 or less.

5. The laminating film for use in organic glass according to claim 1, wherein the electron beam-curable resin composition contains a triazine-based ultraviolet absorber and/or a hindered amine-based light stabilizer.

6. The laminating film for use in organic glass according to claim 2, wherein a primer layer forming resin composition for forming a primer layer is a composition containing a polymer polyol and a curing agent.

7. The laminating film for use in organic glass according to claim 2, wherein the primer layer forming resin composition for forming a primer layer contains a triazine-based ultraviolet absorber and/or a hindered amine-based light stabilizer.

8. The laminating film for use in organic glass according to claim 1, wherein the resin comprising the resin film is at least one selected from polycarbonate resin, acrylic resin and polyester resin.

9. The laminating film for use in organic glass according to claim 1, which is integrated with a resin for a base substrate by an injection molding method.

10. An organic glass comprising a resin base on the resin film side of an laminating film for use in organic glass including a resin film containing a triazine-based ultraviolet absorber, and a surface protective layer, the surface protective layer including a cured product of an electron beam-curable resin composition containing a polycarbonate (meth)acrylate and a polyfunctional (meth)acrylate at a mass ratio of 98:2 to 50:50.

11. A method for producing a laminating film for use in organic glass, the method including, sequentially, the steps of:
(I) forming an uncured resin layer on a resin film containing a triazine-based ultraviolet absorber by applying an electron beam-curable resin composition containing a polycarbonate (meth)acrylate and a polyfunctional (meth)acrylate at a mass ratio of 98:2 to 50:50; and
(II) forming a surface protective layer by irradiating the uncured resin layer with an electron beam to cure the uncured resin layer.

12. The method for producing a laminating film for use in organic glass according to claim 11, wherein in the step (I), an uncured resin layer is formed on a resin film by applying a primer layer forming resin composition, and then applying an electron beam-curable resin composition.

13. A method for producing an organic glass, the method including, sequentially, the steps of:
(α) disposing the laminating film for use in organic glass according to claim 1 in a mold;
(β) injecting a resin for a base substrate into the mold; and
(γ) taking an organic glass from the mold after the resin for a base substrate is cooled.

14. The laminating film for use in organic glass according to claim 2, wherein the polyfunctional (meth)acrylate is tri- or more functional.

15. The laminating film for use in organic glass according to claim 2, wherein the polycarbonate (meth)acrylate has a weight average molecular weight of more than 2000 and 50000 or less.

16. The laminating film for use in organic glass according to claim 2, wherein the electron beam-curable resin composition contains a triazine-based ultraviolet absorber and/or a hindered amine-based light stabilizer.

17. The laminating film for use in organic glass according to claim 3, wherein a primer layer forming resin composition for forming a primer layer is a composition containing a polymer polyol and a curing agent.

18. The laminating film for use in organic glass according to claim 3, wherein the primer layer forming resin composition for forming a primer layer contains a triazine-based ultraviolet absorber and/or a hindered amine-based light stabilizer.

19. The laminating film for use in organic glass according to claim 2, wherein the resin comprising the resin film is at least one selected from polycarbonate resin, acrylic resin and polyester resin.

20. The laminating film for use in organic glass according to claim 2, which is integrated with a resin for a base substrate by an injection molding method.
